(19) United States
(12) Patent Application Publication
(10) Pub. No.: US 2026/0110192 A1
(43) Pub. Date: Apr. 23, 2026

(54) REKEYABLE LOCK CYLINDER

(71) Applicant: Schlage Lock Company LLC, Carmel, IN (US)

(72) Inventors: James Nye, Colorado Springs, CO (US); Darryl R. Doerr, Colorado Springs, CO (US)

(21) Appl. No.: 18/923,963

(22) Filed: Oct. 23, 2024

(51) Int. Cl. E05B 27/00

(52) U.S. Cl. CPC E05B 27/005; E05B 27/0082

(57) ABSTRACT

An exemplary lock cylinder has an operating configuration and a rekey configuration, and generally includes a shell, a plug, and a rekey bar. The shell includes a body portion and a tower. The plug is mounted in the body portion for rotation between a home position and a rotated position, and includes a faceplate having an aperture. The rekey bar is mounted in the tower for movement between a first position and a second position. With the plug in the home position, the aperture is misaligned with the tower and the rekey bar is inaccessible. With the plug in the rotated position, the aperture is aligned with the tower and the rekey bar is accessible such that insertion of a tool through the aperture moves the rekey bar from the first position to the second position, thereby moving the lock cylinder from the operating configuration to the rekey configuration.

### TECHNICAL FIELD

The present disclosure generally relates to rekeyable lock cylinders, and more particularly but not exclusively relates to rekeyable lock cylinders.

### BACKGROUND

Certain existing rekeyable lock cylinders utilize a set of configurable tumblers that can be adjusted to rekey the lock cylinder. Typically, these configurable tumblers include a first tumbler component and a second tumbler component that are selectively engaged with one another. However, there remain difficulties in ensuring accurate and repeatable recoding of the lock cylinder, particularly given the constraints imposed by attempting to fit the working components into the relatively small envelopes provided in existing standard lock cylinder formats. For these reasons among others, there remains a need for further improvements in this technological field.

### SUMMARY

An exemplary lock cylinder has an operating configuration and a rekey configuration, and generally includes a shell, a plug, and a rekey bar. The shell includes a body portion and a tower. The plug is mounted in the body portion for rotation between a home position and a rotated position, and includes a faceplate having an aperture. The rekey bar is mounted in the tower for movement between a first position and a second position. With the plug in the home position, the aperture is misaligned with the tower and the rekey bar is inaccessible. With the plug in the rotated position, the aperture is aligned with the tower and the rekey bar is accessible such that insertion of a tool through the aperture moves the rekey bar from the first position to the second position, thereby moving the lock cylinder from the operating configuration to the rekey configuration. Further embodiments, forms, features, and aspects of the present application shall become apparent from the description and figures provided herewith.

### BRIEF DESCRIPTION OF THE FIGURES

FIG. 1 is an assembly view of a lock system according to certain embodiments.

FIG. 2 is an exploded assembly view of a lock cylinder according to certain embodiments.

FIG. 3 is another exploded assembly view of the lock cylinder.

FIG. 4 is a perspective illustration of a configurable tumbler according to certain embodiments.

FIG. 5 illustrates the configurable tumbler in a blocking position and an operational state.

FIG. 6 illustrates the configurable tumbler in an unblocking position and the operational state.

FIG. 7 illustrates the configurable tumbler in the unblocking position and a recoding state.

FIG. 8 is a front end view of the lock cylinder with the plug in a home position.

FIG. 9 is a cross-sectional view taken along the line IX-IX of FIG. 8, and illustrates the lock cylinder with a rekey bar in a first or holding position.

FIG. 10 is a cross-sectional view taken along the line X-X of FIG. 8, and illustrates the lock cylinder with a change bar in an operating position.

FIG. 11 is a front end view of the lock cylinder with the plug in a rotated or rekey position.

FIG. 12 is a cross-sectional view taken along the line XII-XII of FIG. 11, and illustrates the lock cylinder with the rekey bar holding the change bar in the operational position.

FIG. 13 is a cross-sectional view similar to that of FIG. 12, and illustrates the lock cylinder with the rekey bar in a rekey position prior to movement of the change bar to a rekey position.

FIG. 14 is a cross-sectional view similar to that of FIG. 12, and illustrates the lock cylinder with the rekey bar in the rekey position and the change bar in the rekey position.

FIG. 15 is a schematic flow diagram of a process according to certain embodiments.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

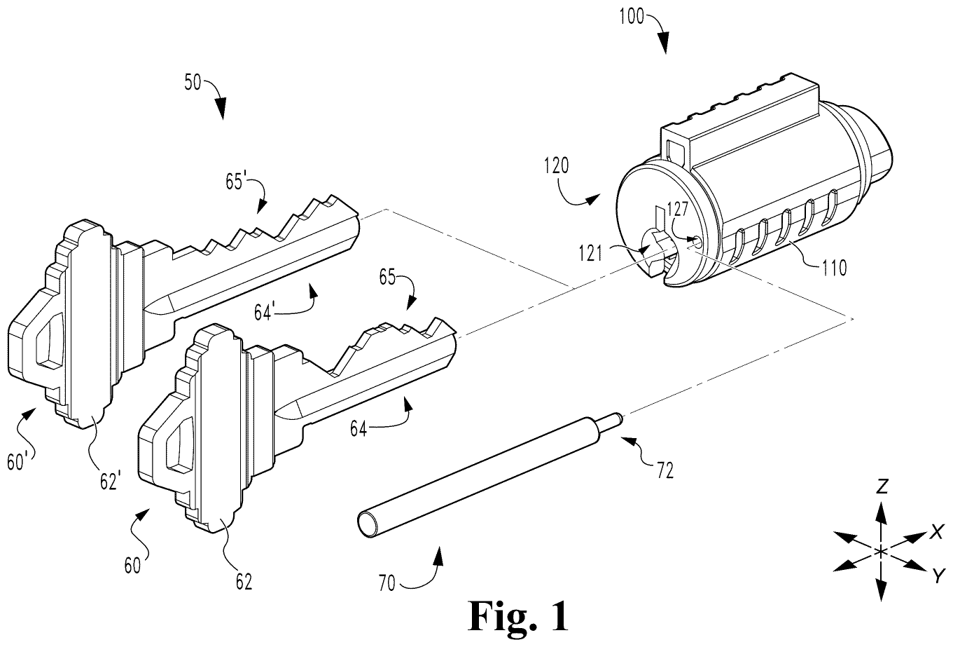

As used herein, the terms “longitudinal,” “lateral,” and “transverse” may be used to denote motion or spacing along three mutually perpendicular axes, wherein each of the axes defines two opposite directions. In the coordinate system illustrated in FIG. 1, the X-axis defines first and second longitudinal directions, the Y-axis defines first and second lateral directions, and the Z-axis defines first and second transverse directions. These terms are used for ease and convenience of description, and are without regard to the orientation of the system with respect to the environment. For example, descriptions that reference a longitudinal direction may be equally applicable to a vertical direction, a horizontal direction, or an off-axis orientation with respect to the environment.

Furthermore, motion or spacing along a direction defined by one of the axes need not preclude motion or spacing along a direction defined by another of the axes. For example, elements that are described as being “laterally offset” from one another may also be offset in the longitudinal and/or transverse directions, or may be aligned in the longitudinal and/or transverse directions. Moreover, the term “transverse” may also be used to describe motion or spacing that is non-parallel to a particular axis or direction. For example, an element that is described as being “movable in a direction transverse to the longitudinal axis” may move in a direction that is perpendicular to the longitudinal axis and/or in a direction oblique to the longitudinal axis. The terms are therefore not to be construed as limiting the scope of the subject matter described herein to any particular arrangement unless specified to the contrary.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

With reference to FIG. 1, illustrated therein is a lock system 50 according to certain embodiments. The lock system 50 generally includes a lock cylinder 100 according to certain embodiments, and further includes a first key 60 operable to actuate the lock cylinder 100, and a rekeying tool 70 that facilitates rekeying of the lock cylinder 100 to a configuration in which the lock cylinder 100 is operable to be actuated by a second key 60′.

The first key 60 includes a head 62 and a shank 64 extending from the head 62, and the shank 64 includes a bitting surface 65 that embodies a particular key code. Similarly, the second key 60′ includes a head 62′ and a shank 64′ having a bitting surface 65′ that embodies a particular key code. In the illustrated form, the key codes for the keys 60, 60′ are different such that the bitting surfaces 65, 65′ are of different configurations. The lock cylinder 100 has a first configuration in which the first key 60 is operable to actuate the cylinder 100 and the second key 60′ is inoperable to actuate the cylinder 100, and a second configuration in which the first key 60 is inoperable to actuate the cylinder 100 and the second key 60′ is operable to actuate the cylinder 100. As described herein, the rekeying tool 70 is configured to facilitate rekeying of the lock cylinder 100 between the first configuration and the second configuration.

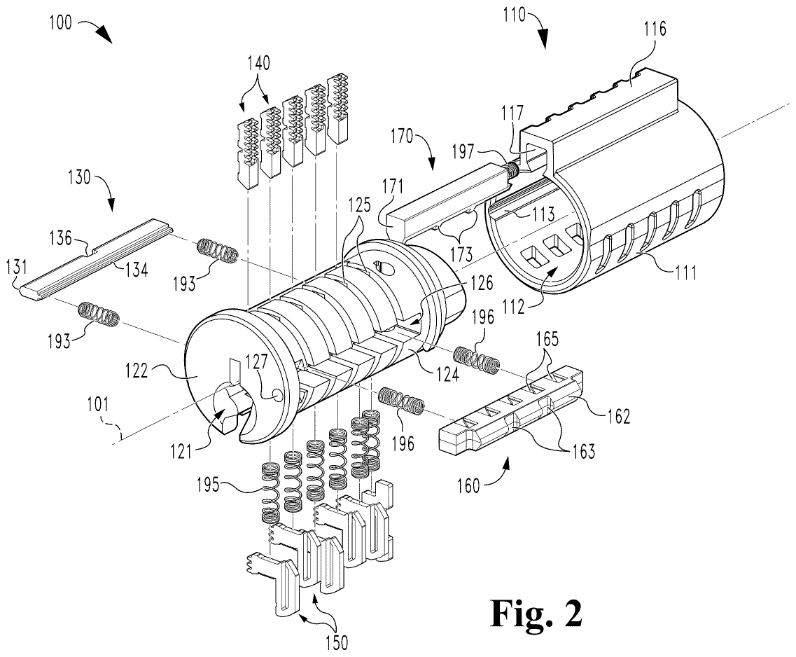

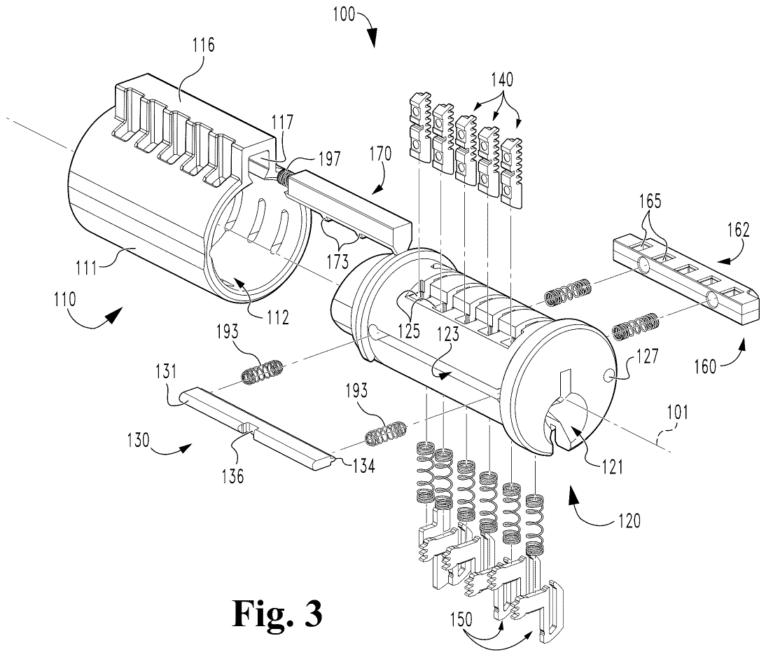

With additional reference to FIGS. 2 and 3, the lock cylinder 100 generally includes a shell 110 configured for mounting in a lock housing, a plug 120 rotatably mounted in the shell 110, a lock bar 130 operable to selectively prevent rotation of the plug 120 relative to the shell 110, and a plurality of configurable tumblers 104 operable to selectively retain the lock bar 130 in a locking position. As described herein, each configurable tumbler 104 generally includes a rack pin 140 operable to engage the lock bar 130 and a key follower 150 selectively coupled with the corresponding rack pin 140. The lock cylinder 100 further includes a change bar 160 operable to facilitate coupling and decoupling of the configurable tumblers 104, and a rekey bar 170 operable to selectively retain the change bar 160 in a coupling position.

The shell 110 generally includes a body portion 111 defining a cylindrical chamber 112, and a lock bar groove 113 operable to receive a portion of the lock bar 130. The lock bar groove 113 extends longitudinally along the interior of the body portion 111 and is open to the chamber 112. The shell 110 further includes a bible or tower 116 that projects radially from the body portion 111 and defines a channel 117 in which the rekey bar 170 is mounted for sliding longitudinal movement. The channel 117 is open to the chamber 112, and is operable to receive a portion of the change bar 160 as described herein.

The plug 120 generally includes a longitudinally extending keyway 121 operable to receive the shank 64 of the key 60, a face plate 122 at a proximal end of the plug 120, and a cylindrical body 124 extending distally from the face plate 122. Formed within the body 124 are a longitudinally-extending lock bar channel 123 in which the lock bar 130 is seated, a plurality of tumbler cavities 125 in which the tumblers 104 are seated, and a longitudinally-extending change bar channel 126 in which the change bar 160 is seated. The plug 120 includes a tool-receiving aperture 127 that extends longitudinally through the face plate 122 and facilitates manipulation of the rekey bar 170 by the rekey tool 70 as described herein.

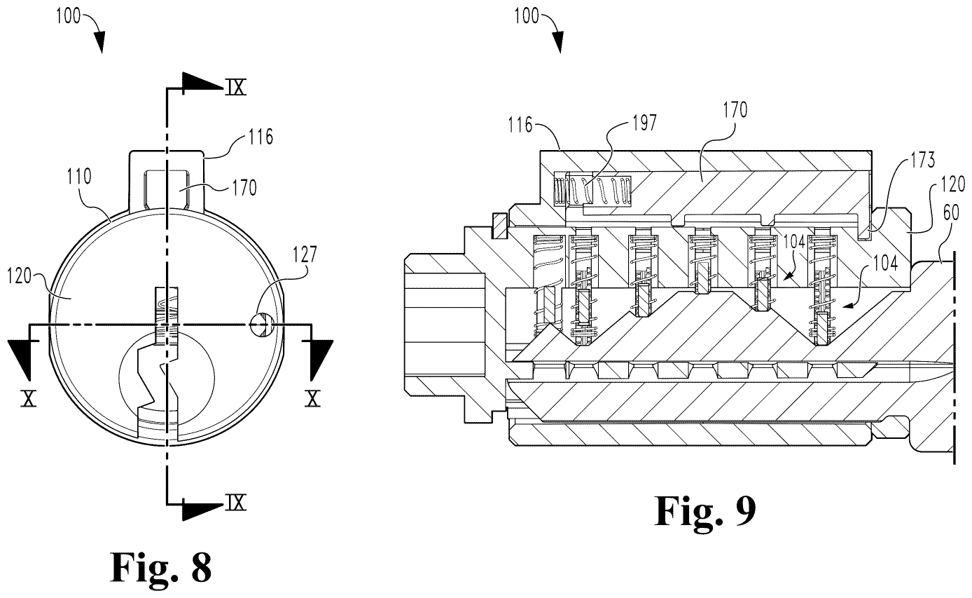

The lock bar 130 generally includes a radially outer side defining a cam surface 131 and a radially inner side defining a ridge 134. The lock bar 130 is movably received in the lock bar groove 113 for sliding movement between a radially outward locking position (FIG. 6) and a radially inward unlocking position (FIG. 7). The lock bar 130 may be biased toward the locking position, for example by one or more lock bar springs 193. When the plug 120 is in its home position (FIG. 8), the cam surface 131 is received in the lock bar groove 113. In this state, attempted rotation of the plug 120 will cause the groove 113 to engage the cam surface 131 and thereby urge the lock bar 130 radially inward from the locking position toward the unlocking position. When such radially inward motion of the lock bar 130 is blocked, the lock bar 130 prevents rotation of the plug 120. As described herein, the tumblers 104 are operable to selectively prevent the inward motion of the lock bar 130, and are configured to permit the inward motion when an appropriate key is fully inserted into the keyway 121. In the illustrated form, the radially outer side of the lock bar 130 also includes a lock bar notch 136, the function of which is described herein.

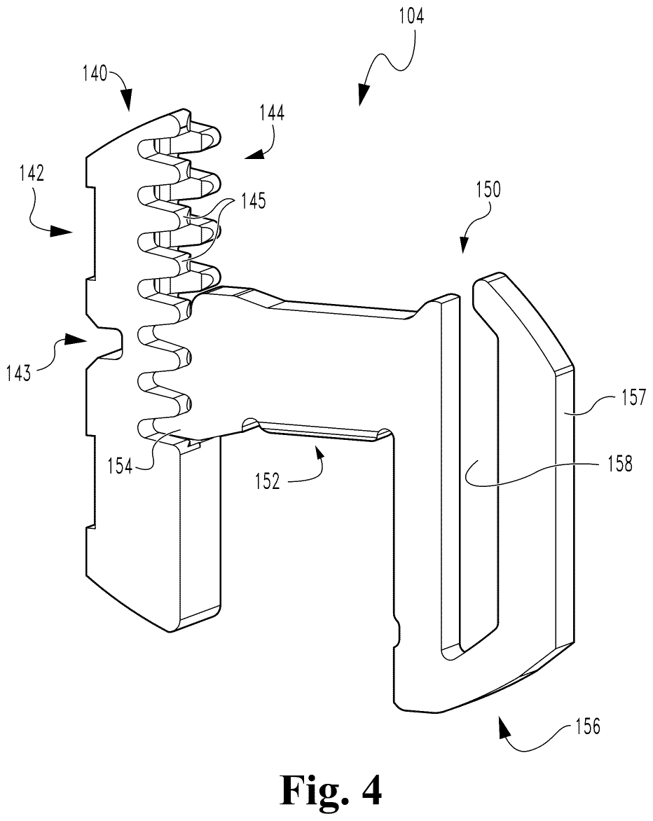

With additional reference to FIG. 4, each configurable tumbler 104 includes a corresponding and respective first tumbler component and a corresponding and respective second tumbler component. While other forms are contemplated, in the illustrated embodiment, the first tumbler components are provided in the form of rack pins 140, and the second tumbler components are provided in the form of key followers 150. Each rack pin 140 generally includes a radially outer blocking surface 142 having formed therein a notch 143 operable to receive a portion of the ridge 134. An opposite side of the rack pin 140 defines a rack 144 having a plurality of teeth 145. Each key follower 150 generally includes a key rider 152, at least one tooth 154 operable to engage the rack 144, and an engagement portion 156 including a finger 157 and a slot 158.

The change bar 160 is movably seated in the change bar groove 116 for movement between an operating position (FIG. 12) and a rekey position (FIG. 14). The change bar 160 may be biased toward the rekey position, for example by one or more change bar springs 196. A radially outer side of the change bar 160 includes a cam surface 162 having at least one notch 163 formed therein, and in the illustrated form, the cam surface 162 includes a plurality of notches 163 that are spaced apart in the longitudinal direction. As described herein, each notch 163 is operable to receive a corresponding projection 173 of the rekey bar 170 to selectively permit movement of the change bar 160 from its operating position to its rekey position. The change bar 160 also includes a plurality of longitudinally-spaced apertures 165, each of which receives the finger 157 of a corresponding key follower 150 such that the key followers 150 and the change bar 160 are coupled for joint lateral movement in a direction transverse to the longitudinal axis 101. As described herein, movement of the change bar 160 between its operating position and its rekey position also moves the key followers 150 laterally to thereby move each of the tumblers 104 between an operational or engaged state (FIG. 6) and a rekey or disengaged state (FIG. 7).

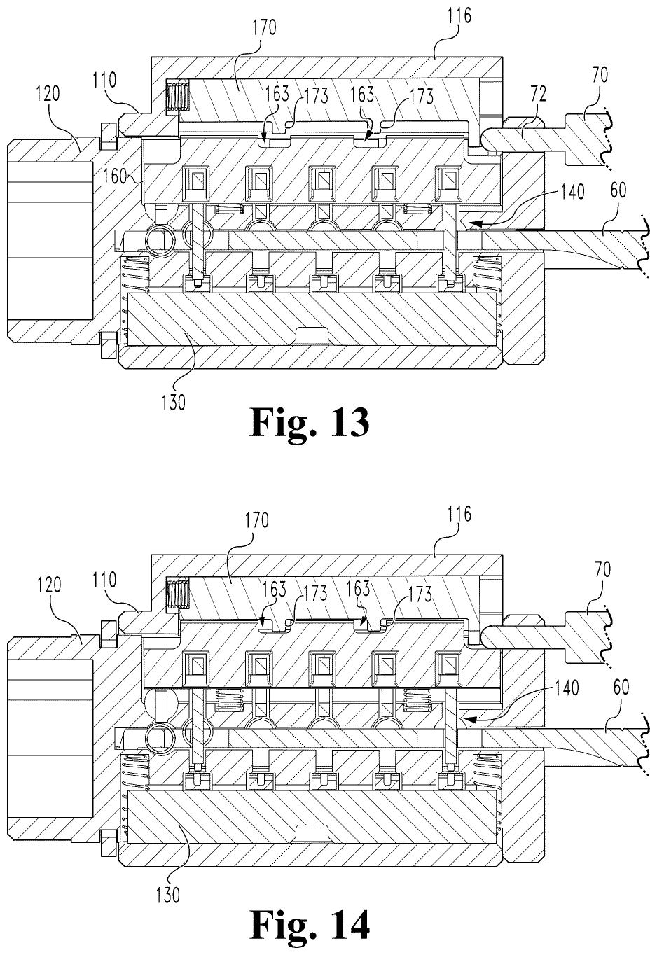

The rekey bar 170 is slidably mounted in the tower channel 117 for longitudinal movement between a holding position (FIG. 12) and a release position (FIG. 13), and may be biased toward its holding position, for example by one or more rekey bar springs 197. The rekey bar 170 includes one or more projections 173 operable to enter the one or more notches 163 of the change bar 160. In certain embodiments, the proximal end of the rekey bar 170 may include a tab 171 that facilitates engagement of the tool 70 with the rekey bar 170.

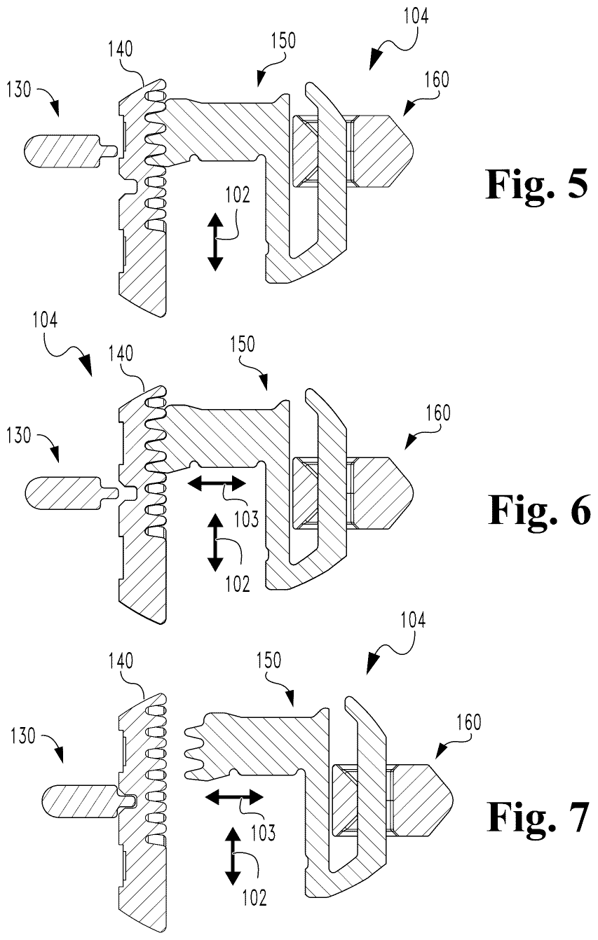

With additional reference to FIGS. 5 and 6, each configurable tumbler 104 is mounted in a corresponding one of the tumbler cavities 125 for sliding movement along a tumbler sliding axis 102 between a blocking position (FIG. 5) and an unblocking position (FIG. 6). One or more of the tumblers 104 may be biased toward its blocking position, for example by a corresponding tumbler spring 194. When the tumbler 104 is in its blocking position (FIG. 5), the notch 143 is misaligned with the ridge 134 such that radially inward movement of the lock bar 130 is prevented. When at least one of the configurable tumblers 104 is in the blocking position, the lock cylinder 100 is in a locked condition, and the plug 120 cannot be rotated from its home position. When the tumbler 104 is in its unblocking position (FIG. 6), the notch 143 is aligned with the ridge 134 and does not prevent radially inward movement of the lock bar 130. When each of the tumblers 104 is in its unblocking position, the lock bar 130 is free to move from its locking position to its unlocking position. As a result, the lock cylinder 100 is in an unlocked condition, and the plug 120 can be rotated relative to the shell 110.

With additional reference to FIG. 7, each configurable tumbler 104 also has an engaged state (FIGS. 5 and 6) for standard operation and a disengaged state (FIG. 7) for recoding. When the tumbler 104 is in the operational or engaged state (FIGS. 5 and 6), the tooth 154 of the key follower 150 is engaged with the rack 144 of the rack pin 140 such that the rack pin 140 and the key follower 150 are coupled for joint movement along a tumbler sliding axis 102. When the tumbler 104 is in the recoding or disengaged state (FIG. 7), the key follower tooth 154 is disengaged from the rack 144 such that the key follower 150 is movable along the tumbler sliding axis 102 while the rack pin 140 remains stationary (e.g., as a result of the notch 143 receiving the ridge 134). As described herein, the tumbler 104 can be moved between the engaged state and the disengaged state by depressing the rekey bar 170 to thereby move the change bar 160 along a lateral axis 103 transverse to the longitudinal axis 101 and the sliding axis 102.

With additional reference to FIG. 8, illustrated therein is the lock cylinder 100 with the plug 120 in a home position and prior to insertion of the key 60. In this state, one or more of the tumblers 104 is in its blocking position, thereby preventing rotation of the plug 120 from its home position. With the plug 120 in its home position, the tool-receiving aperture 127 is misaligned with the tower 116, and is instead aligned with a rim of the shell 110. As a result, the user cannot access the rekey bar 170 with the tool 70. While FIG. 8 illustrates the front end of the tower 116 as being open such that the rekey bar 170 is accessible, those skilled in the art will readily recognize that when the lock cylinder 100 is installed to a housing, the housing may cover the proximal end face of the tower 116 and block access to the rekey bar 170.

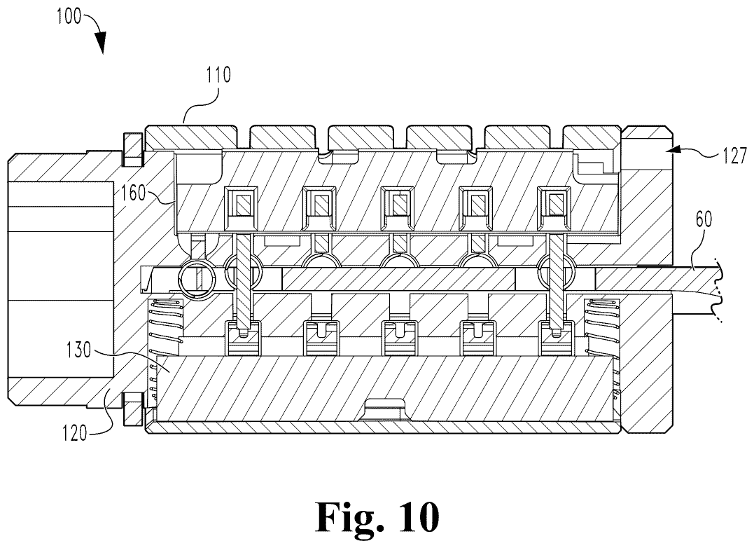

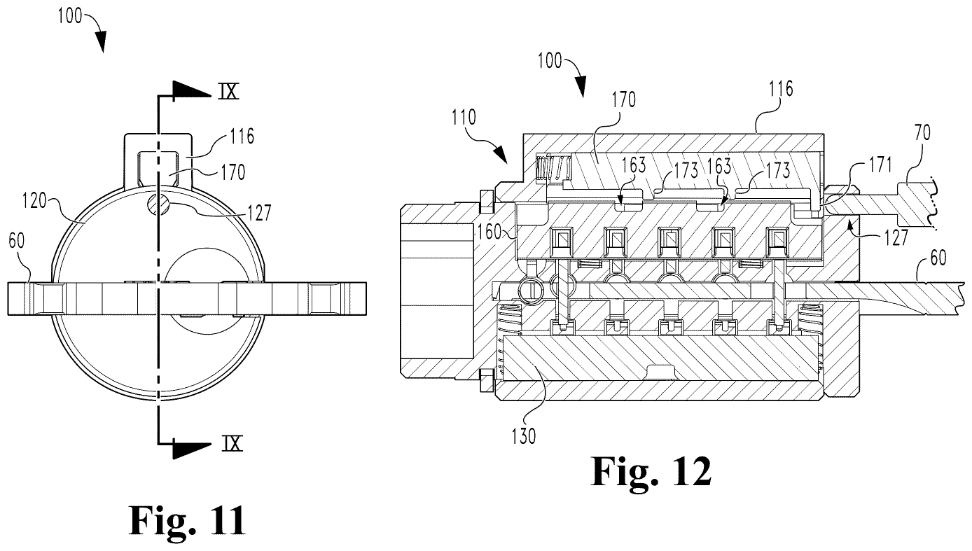

With additional reference to FIGS. 9 and 10, upon full insertion of the key 60, each of the tumblers 104 is moved to its unblocking position, in which the notch 143 is aligned with the ridge 134 as illustrated in FIG. 5. As a result, the plug 120 is operable to be rotated to its rotated position (FIG. 11). Such rotation of the plug 120 causes the lock bar 130 to cam inward toward its inner unblocking position as the ridge 134 enters the notches 143. Moreover, the change bar 160 is held in its inner operating position by the internal wall of the shell 110. As a result, the tumblers 104 are retained in their engaged states during rotation of the shell 110 from its home position to its rotated position.

With additional reference to FIG. 11, illustrated therein is the lock cylinder 100 after the key 60 has been inserted and the plug 120 has been rotated to its rotated position. With the plug 120 in the rotated position, the tool-receiving aperture 127 is aligned with the tower 116 such that the tab 171 is accessible via the aperture 127. As a result, the user is able to insert the tip 72 of the tool 70 into the aperture 127 to engage the tab 171 and depress the rekey bar 170 from its holding position (FIG. 12) toward its release position (FIGS. 13 and 14).

With additional reference to FIG. 12, when the plug 120 is in the rotated position, the change bar 160 is aligned and engaged with the rekey bar 170. Prior to use of the tool 70, the projections 173 are engaged with the outer surface of the change bar 160 and thereby retain the change bar 160 in its inner operating position against the bias of the change bar springs 196. As a result, the lock cylinder 100 can continue to function as a typical lock cylinder when the rekey tool 70 is not in use.

With additional reference to FIGS. 13 and 14, when the plug 120 is in the rotated position, the user may drive the rekey bar 170 from its holding position (FIG. 12) to its release position (FIGS. 13 and 14) by inserting the tool tip 72 via the aperture 127 and depressing the tab 171. Once the protrusions 173 become aligned with the change bar notches 163 (FIG. 13), the change bar 163 is urged outward toward its rekey position (FIG. 14), for example by change bar springs 196. When the change bar 163 is in its rekey position, the rekey bar 170 is retained in its release position by engagement of the protrusions 173 with the proximal ends of the notches 163. As a result, the rekey bar 170 will be retained in the release position even in the event that the user removes the tool 70 from the aperture 127.

As will be appreciated, the lateral movement of the change bar 160 from its operating position to its rekey position carries the key followers 150 away from the rack pins 140. This moves the tumblers 104 from their engaged states to their disengaged states, thereby moving the lock cylinder 100 from its operating configuration (FIG. 13) to its rekey configuration (FIG. 14). The lock cylinder 100 is thus ready for rekeying. In order to rekey the cylinder 100, the user may retain the plug 120 in its rotated position while removing the first key 60 and subsequently inserting the second key 60′. Insertion of the second key 60′ while the tumblers 104 are in the disengaged state places the key followers 150 in the appropriate positions for unlocking in response to insertion of the second key 60′. The user may then return the plug to its home position by rotating the inserted key 60′. As the plug 120 returns to its home position, the inner wall of the shell 110 engages the cam surface 162 of the change bar 160, thereby camming the change bar 160 inward to return to its operating position and returning the tumblers 104 return to the engaged state. The second key 60′ can then be removed to complete rekeying of the cylinder 100. Upon such completion of the rekeying, lock cylinder 100 will be operable by the second key 60′ and not by the first key 60.

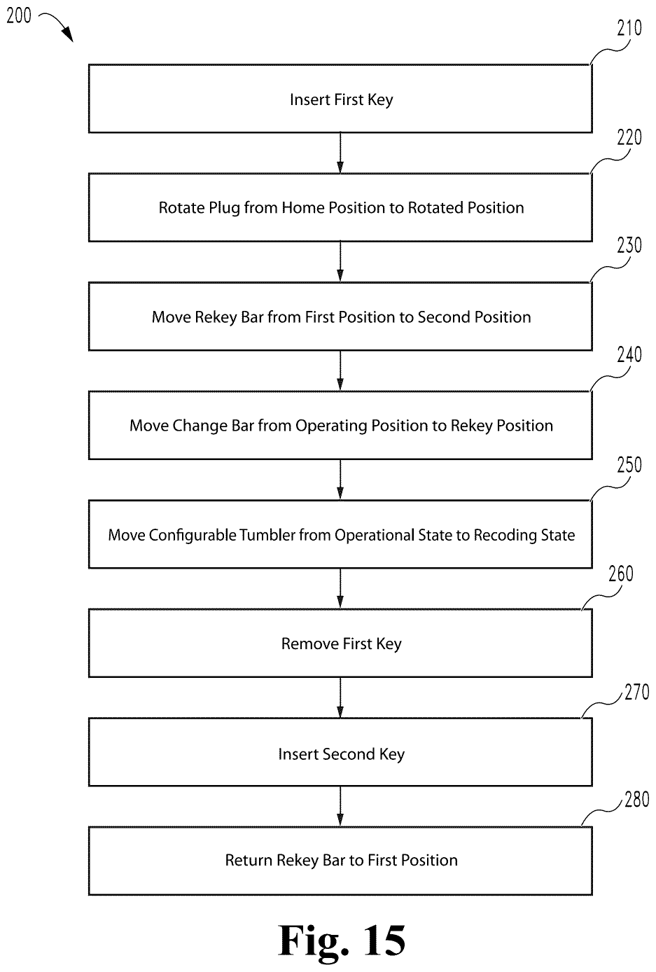

With additional reference to FIG. 15, an exemplary rekeying process 200 that may be performed using the lock system 50 is illustrated. Blocks illustrated for the processes in the present application are understood to be examples only, and blocks may be combined or divided, and added or removed, as well as re-ordered in whole or in part, unless explicitly stated to the contrary. Additionally, while the blocks are illustrated in a relatively serial fashion, it is to be understood that two or more of the blocks may be performed concurrently or in parallel with one another. Moreover, while the process 200 is described herein with specific reference to the lock system 50 illustrated in FIGS. 1-14, it is to be appreciated that the process 200 may be performed with systems having additional and/or alternative features.

The process 200 may be performed with a lock cylinder that includes a shell, a plug rotatably mounted in the shell, a configurable tumbler operable to selectively prevent rotation of the plug, and a rekey bar mounted in a tower of the shell. For example, the process 200 may be performed using the lock cylinder 100, which generally includes a shell 110, a plug 120 rotatably mounted in the shell 110, a configurable tumbler 104 operable to selectively prevent rotation of the plug 120, and a rekey bar 170 mounted in a tower 116 of the shell 110. In certain forms, the lock cylinder may include a change bar operable to move the configurable tumbler between an engaged or operational state and a disengaged or recoding state. For example, the lock cylinder 100 may include a change bar 160 operable to move the configurable tumbler 104 between the operational state (FIG. 6) and the recoding state (FIG. 7). In certain forms, the lock cylinder may include a lock bar operable to selectively prevent rotation of the plug based upon a position of the configurable tumbler. For example, the lock cylinder 100 may include a lock bar 130 operable to selectively prevent rotation of the plug 120 based upon a position of the configurable tumbler 104. In certain embodiments, the lock cylinder may be part of a system that further includes a first key and a rekeying tool. For example, the lock cylinder 100 may be a part of the system 50, which includes a first key 60 and a rekeying tool 70. In certain embodiments, the system may further include a second key, such as the second key 60′.

The process 200 may include block 210, which generally involves inserting a first key into the lock cylinder. For example, block 210 may involve inserting the first key 60 into the keyway 121 of the plug 120. When the lock cylinder 100 is coded to the first key 60, such insertion of the first key 60 moves the lock cylinder 100 from a locked state, in which at least one configurable tumbler 104 is in a locking position, to an unlocked state, in which each configurable tumbler 104 is in an unlocking position. As a result, insertion of the first key 60 unlocks the cylinder 100 and permits rotation of the plug 120 relative to the shell 110.

The process 200 may include block 220, which generally involves rotating the plug from a home position to a rotated position. For example, block 220 may involve rotating the inserted first key 60 to thereby rotate the plug 120 from its home position (FIG. 8) to its rotated or rekey position (FIG. 11). Rotation of the plug 120 to its rotated position aligns the change bar 160 with the rekey bar 170, the projections 173 of which retain the change bar 160 in its operating position (FIG. 12) against the biasing of the change bar springs 196.

The process 200 may include block 230, which generally involves moving the rekey bar from a first position to a second position. For example, block 230 may involve inserting the tip 72 of the tool 70 via the aperture 127 to thereby engage the tab 171 and longitudinally drive the rekey bar 170 from its holding position (FIG. 12) to its release position (FIG. 13). Such depression of the rekey bar 170 aligns the rekey bar projection(s) 173 with the change bar notch(es) 163 to thereby permit radially outward movement of the change bar 160 from its operational position (FIG. 13) to its rekey position (FIG. 14).

The process 200 may include block 240, which generally involves moving the change bar from its operating position to its rekey position. Block 240 may be performed in response to the movement of the rekey bar 170 in block 230 from its first position to its second position. For example, block 240 may involve the change bar spring(s) 196 driving the change bar 160 radially outward from its operational position (FIG. 13) to its rekey position (FIG. 14) as the rekey bar 170 moves from its first or hold position to its second or release position. Once the change bar 160 reaches its rekey position, engagement with the change bar 160 may retain the rekey bar 170 in its second or depressed position, for example due to engagement of the protrusion(s) 173 with the notch(es) 163. In such forms, the tool 70 may be removed from the aperture 127 after the change bar 160 has adopted its rekey position.

The process 200 may include block 250, which generally involves moving the configurable tumbler from its operational state to its recoding state. Block 250 may be performed in response to movement of the change bar 160 in block 240 from its operational position to its rekey position. For example, block 250 may involve the change bar 160 carrying the key follower 150 along the lateral axis 103 away from the rack pin 140 to thereby disengage the configurable tumbler 104. With the configurable tumbler 104 in its recoding state, the key follower 150 can be moved along the tumbler sliding axis 102 while the lock bar 130 retains the rack pin 140 in its unblocking position.

The process 200 may include block 260, which generally involves removing the first key. For example, block 260 may involve removing the first key 60 from the keyway 121 while the plug 120 remains in its rotated position.

The process 200 may include block 270, which generally involves inserting a second key. For example, block 270 may involve inserting the second key 60′, which as noted above has a different key cut as compared to the first key 60. Insertion of the second key 60′ places the key followers 150 in their new unlocking positions, where they will be subsequently rejoined with the rack pins 140 to reconfigure the configurable tumblers 104.

The process 200 may include block 280, which generally involves returning the rekey bar to its first position while the second key remains inserted. For example, block 280 may involve rotating the inserted second key 60′ to thereby return the plug 120 from its rotated position to its home position. As the plug 120 returns to its home position, the shell 110 engages the change bar cam surface 162, thereby driving the change bar 160 radially inward toward its operational position. Movement of the change bar 160 to its operational position returns the configurable tumblers 104 from their recoding state to their operating state by re-engaging the rack pins 140 and the key followers 150. Such movement of the change bar 160 also permits the rekey bar 170 to return to its first or holding position under force of the rekey bar spring 197. In certain forms, such return of the rekey bar 170 may mark the completion of the rekey process.

As should be evident from the foregoing, the illustrated system 50 and process 200 involve the use of a rekey bar 170 that is positioned in the tower 116 of the shell 110. This can represent a significant savings in real estate or envelope space in comparison to certain existing designs, such as those in which a longitudinally-movable rekeying element is received in the plug. Moreover, in embodiments in which the components that selectively prevent rotation of the plug 120 (including the configurable tumblers 104 and lock bar 130) are primarily housed in the plug 120, the tower 116 may otherwise remain relatively unused, resulting in fewer components that may interfere with operation of the rekey bar 170.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A rekeyable lock cylinder, comprising:
a shell including a body portion and a tower extending radially from the body portion;
a plug rotatably mounted in the body portion;
a configurable tumbler operable to selectively prevent rotation of the plug, the configurable tumbler comprising a first tumbler component and a second tumbler component;
a rekey bar slidably mounted in the tower for movement between a hold position and a release position;
wherein, with the rekey bar in the hold position, the configurable tumbler is retained in an engaged state in which the first tumbler component and the second tumbler component are engaged with one another for joint movement along a tumbler axis;
wherein, with the rekey bar in the release position, the configurable tumbler is operable to adopt a disengaged state in which the first tumbler component and the second tumbler component are disengaged from one another to thereby facilitate rekeying of the rekeyable lock cylinder; and
wherein the configurable tumbler is configured to move from the engaged state to the disengaged state in response to movement of the rekey bar from the hold position to the release position.

2. The rekeyable lock cylinder of claim 1, further comprising a change bar mounted in the plug for movement between an operating position, in which the change bar maintains the configurable tumbler in the engaged state, and a rekey position, in which the change bar maintains the configurable tumbler in the disengaged state.

3. The rekeyable lock cylinder of claim 2, wherein the rekey bar is configured to hold the change bar in the operating position when the rekey bar is in the hold position, and to permit movement of the change bar to the rekey position when the rekey bar is in the release position.

4. The rekeyable lock cylinder of claim 3, wherein, when the rekey bar is in the hold position, a protrusion is misaligned with a notch such that the change bar is held in the operating position;
wherein, when the rekey bar is in the release position, the protrusion is aligned with the notch such that movement of the change bar from the operating position to the rekey position causes the protrusion to enter the notch.

5. The rekeyable lock cylinder of claim 4, wherein the change bar is biased toward the rekey position.

6. The rekeyable lock cylinder of claim 1, wherein the plug has a home position and a rotated position; and
wherein an aperture of the plug is aligned with the tower when the plug is in the rotated position to thereby enable access to the rekey bar.

7. The rekeyable lock cylinder of claim 1, wherein the plug is rotatable about a longitudinal axis; and
wherein the rekey bar is configured to move longitudinally between the hold position and the release position.

8. The rekeyable lock cylinder of claim 1, wherein the second tumbler component is configured to move along a lateral axis transverse to the tumbler axis during movement of the configurable tumbler between the engaged state and the disengaged state.

9. A lock cylinder having an operating configuration and a rekey configuration, the lock cylinder comprising:
a shell comprising a body portion and a tower;
a plug mounted in the body portion for rotation about a longitudinal axis between a home position and a rotated position, the plug comprising a faceplate having an aperture formed therein; and
a rekey bar mounted in the tower for sliding movement between a first position and a second position longitudinally offset from the first position;
wherein, with the plug in the home position, the aperture is misaligned with the tower and the rekey bar is inaccessible; and
wherein, with the plug in the rotated position, the aperture is aligned with the tower and the rekey bar is accessible such that insertion of a tool through the aperture moves the rekey bar from the first position to the second position, thereby moving the lock cylinder from the operating configuration to the rekey configuration.

10. A lock cylinder having an operating configuration and a rekey configuration, the lock cylinder comprising:
a shell comprising a body portion and a tower;
a plug mounted in the body portion for rotation between a home position and a rotated position, the plug comprising a faceplate having an aperture formed therein;
a rekey bar mounted in the tower for sliding movement between a first position and a second position; and
a configurable tumbler mounted in the plug and operable to selectively prevent rotation of the plug relative to the shell;
wherein, with the plug in the home position, the aperture is misaligned with the tower and the rekey bar is inaccessible;
wherein, with the plug in the rotated position, the aperture is aligned with the tower and the rekey bar is accessible such that insertion of a tool through the aperture moves the rekey bar from the first position to the second position, thereby moving the lock cylinder from the operating configuration to the rekey configuration;
wherein the configurable tumbler comprises two tumbler components and has an engaged state, in which the two tumbler components are engaged with one another, and a disengaged state, in which the two tumbler components are disengaged from one another; and
wherein the configurable tumbler is configured to move from the engaged state to the disengaged state in response to movement of the rekey bar from the first position to the second position.

11. The lock cylinder of claim 9, wherein the plug further comprises a body portion extending from the faceplate; and
wherein the rekey bar includes a tab that extends toward the body portion and is positioned directly behind the faceplate.

12. The lock cylinder of claim 9, further comprising a change bar having an operating position in the operating configuration and a rekey position in the rekey configuration;
wherein the rekey bar comprises a protrusion; and
wherein the change bar comprises a notch operable to receive the protrusion when the rekey bar is in the second position to thereby permit movement of the change bar from the operating position to the rekey position.

13. The lock cylinder of claim 9, further comprising:
a change bar having an operating position in the operating configuration and a rekey position in the rekey configuration;
a first tumbler component; and
a second tumbler component selectively engaged with the first tumbler component;
wherein the second tumbler component is engaged with the change bar such that movement of the change bar from the operating position to the rekey position causes the second tumbler component to disengage from the first tumbler component.

14. The lock cylinder of claim 9, further comprising a change bar having an operating position in the operating configuration and a rekey position in the rekey configuration;
wherein, with the rekey bar in the first position, a protrusion is misaligned with a notch to thereby retain the change bar in the operating position; and
wherein, with the rekey bar in the second position, the notch is operable to receive the protrusion to thereby permit movement of the change bar from the operating position to the rekey position.

15. (canceled)

16. A method of rekeying a lock cylinder comprising a shell, a plug rotatably mounted in the shell, a configurable tumbler operable to selectively prevent rotation of the plug, and a rekey bar mounted in a tower of the shell, the method comprising:
inserting a first key into a keyway of the plug, thereby moving the configurable tumbler from a locking position to an unlocking position;
with the configurable tumbler in the unlocking position, rotating the plug from a home position to a rotated position, thereby aligning a tool-receiving aperture of the plug with the tower;
with the plug in the rotated position, engaging the rekey bar with a tool inserted through the tool-receiving aperture, thereby moving the rekey bar from a first position in which the rekey bar prevents rekeying of the lock cylinder to a second position in which the rekey bar permits rekeying of the lock cylinder;
with the rekey bar in the second position, removing the first key from the keyway and subsequently inserting a second key into the keyway, wherein the second key has a different key cut from the first key; and
with the second key inserted into the keyway, returning the rekey bar to the first position, thereby rekeying the lock cylinder.

17. The method of claim 16, wherein returning the rekey bar to the first position comprises rotating the plug.

18. The method of claim 16, wherein movement of the rekey bar from the first position to the second position moves the configurable tumbler from an engaged state, in which two components of the configurable tumbler are engaged with one another, to a disengaged state, in which the two components of the configurable tumbler are disengaged from one another.

19. The method of claim 16, wherein the configurable tumbler comprises a first tumbler component and a second tumbler component selectively engaged with the first tumbler component; and
wherein the lock cylinder further comprises a change bar engaged with the second tumbler component; and
wherein the method further comprises moving the change bar from an operating position to a rekey position in response to movement of the rekey bar from the first position to the second position, thereby disengaging the second tumbler component from the first tumbler component and facilitating rekeying of the lock cylinder.

20. The method of claim 16, wherein movement of the rekey bar from the first position to the second position causes movement of a change bar from an operational position to a rekey position, thereby moving the configurable tumbler from an operational state to a recoding state.
